(19) United States
(12) Patent Application Publication
(10) Pub. No.: US 2020/0380610 A1
(43) Pub. Date: Dec. 3, 2020

(54) PERSONAL AND CONTEXTUAL SPENDING ALERTS AND LIMITS

(71) Applicant: Wells Fargo Bank, N.A., San Francisco, CA (US)

(72) Inventors: Gilberto Lopez, Palo Alto, CA (US); Leslie Rae Witt, Mountain View, CA (US); Brittany Y. Harris, Oakland, CA (US); Zoe Tierney, Chevy Chase, MD (US); Mark McCormick, San Francisco, CA (US); Karen Yu, San Francisco, CA (US); Urmila Raghavan, Oakland, CA (US); Michele Armosino, Orinda, CA (US); Gregory K. Morishige, Berkeley, CA (US); Jonathan Velline, Oakland, CA (US)

(21) Appl. No.: 14/734,724

(22) Filed: Jun. 9, 2015

Related U.S. Application Data
(60) Provisional application No. 62/049,199, filed on Sep. 11, 2014.

(51) Int. Cl. G06Q 40/00; H04W 4/12; H04W 4/02

(52) U.S. Cl. CPC G06Q 40/12; H04W 4/02; H04W 4/12

(57) ABSTRACT

A system includes a server system that includes a processor and instructions stored in non-transitory machine-readable media. The instructions are configured to cause the server system to receive authentication information from a client device. The authentication information relates to a financial account of a user. The instructions are also configured to cause the server system to authenticate the user so as to associate the client device with the financial account of the user. The system also includes a financial notification circuit located on the client device. The financial notification circuit is configured to determine a location of the client device. The financial notification circuit is also configured to provide a notification on the client device alerting the client to not spend money at the location.

### CROSS-REFERENCE TO RELATED PATENT APPLICATIONS

This application claims priority from Provisional Application 62/049,199, filed Sep. 11, 2014, incorporated herein by reference in its entirety.

### BACKGROUND

The present disclosure relates generally to financial management and, more specifically, to personal and contextual spending alerts and limits.

Individuals often rely on computer-based systems to manage their personal finances. Conventional personal financial management systems include software and internet-based systems. Certain systems allow users to create budgets and goals, and to categorize transactions into various categories. However, many systems are cumbersome and difficult to use. For example, conventional systems require a user to log into a website of a financial institution to determine a status of a budget or goal. Certain users log into such a website on an infrequent basis. Therefore, users are often unaware of budget or goal statuses at any given time, such as while shopping.

### SUMMARY

One embodiment relates to a system including a server system that includes a processor and instructions stored in non-transitory machine-readable media. The instructions are configured to cause the server system to receive authentication information from a client device. The authentication information relates to a financial account of a user. The instructions are also configured to cause the server system to authenticate the user so as to associate the client device with the financial account of the user. The system also includes a financial notification circuit located on the client device. The financial notification circuit is configured to determine a location of the client device. The financial notification circuit is also configured to provide a notification on the client device alerting the client to not spend money at the location.

Another embodiment relates to a computer-implemented method. The method includes receiving, by a processor of a banking system, authentication information from a client device. The authentication information relates to a financial account of a user. The method also includes authenticating, by the processor of the banking system, the user so as to associate the client device with a financial account of the user. The method further includes determining, by a financial notification circuit located on the client device, a location of the client device. Further yet, the method includes providing, by the financial notification circuit, a notification on the client device alerting the client to not spend money at the location.

Another embodiment relates to a computer-implemented method of providing automatic financial notifications to a client device. The method includes receiving authentication information from the client device and authenticating the user so as to associate the client device with a financial account of the user. The method also includes receiving a location identifier from the client device and determining an anticipated transaction based on the location identifier. The method further includes determining a budget category based on the anticipated transaction and determining a status of the user's financial account. The status relates to the budget category. Further yet, the method includes transmitting, to the client device, a notification based on the status.

Another embodiment relates to a system for providing automatic financial notifications to a client device. The system includes a data storage system, and a processor and program logic stored in memory and executed by the processor. The program logic includes financial health logic configured to receive authentication information from the client device and to authenticate the user so as to associate the client device with the financial account of the user. The financial health logic is also configured to receive a location identifier from the client device and to determine an anticipated transaction based on the location identifier. The financial health logic is further configured to determine a budget category based on the anticipated transaction and to determine a status of the user's financial account. The status relates to the budget category. Further yet, the program logic is configured to transmit, to the client device, a notification based on the status.

### BRIEF DESCRIPTION OF THE DRAWINGS

FIG. 1 is a block diagram of a data processing system, according to an example embodiment.

FIG. 2 is a block diagram of the client device of FIG. 1, according to an example embodiment.

FIG. 3 is a flow diagram of a method of providing preemptive and contextual financial notifications, according to an example embodiment.

FIG. 4 illustrates an example implementation of the method of FIG. 3, according to an example embodiment.

### DETAILED DESCRIPTION

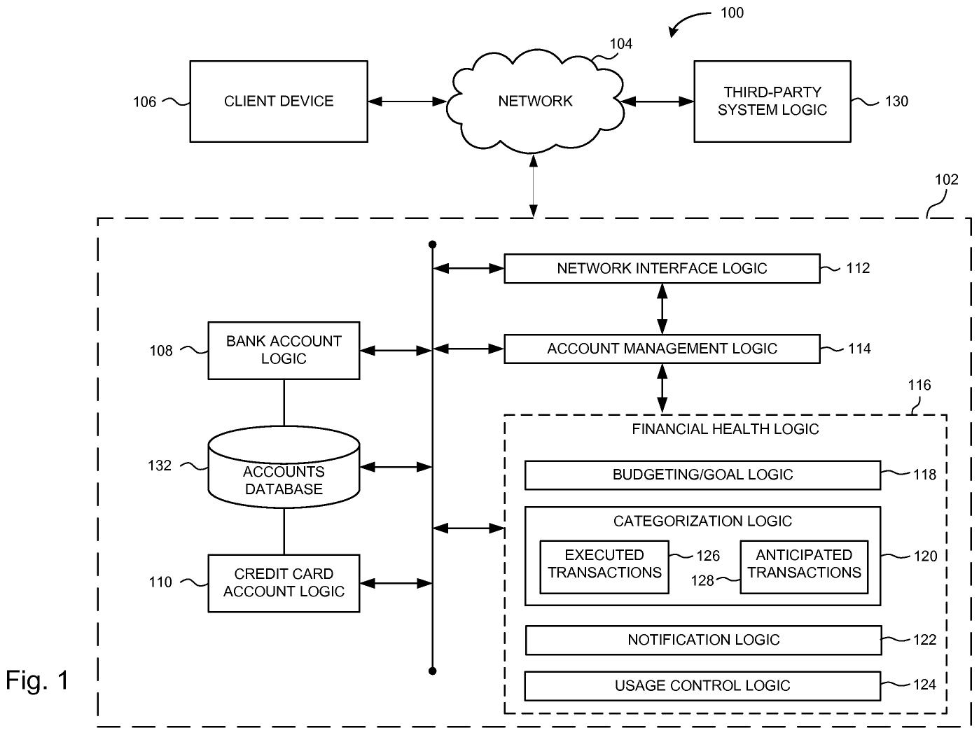

FIG. 1 is a block diagram illustrating a data processing system 100 according to an example embodiment. The data processing system 100 includes a financial management system 102 configured to, among other things, manage personal financial accounts at one or more financial institutions. In the example of FIG. 1, the financial management system 102 is implemented by an enterprise computing system of a financial institution at which a user has one or more financial accounts.

The user may access the financial management system 102 via a network 104 (e.g., the Internet or an intranet) using a client device 106 (e.g., a laptop computer, tablet computer, PDA, smartphone, mobile device, portable media device, wearable device, augmented reality device, etc.) or in another manner. In one embodiment, the user may, for example, access the financial management system 102 through an online banking area of a website or application provided by the bank based on a valid username and password. Upon entering the online banking area of the website or application, the user may be provided with profile information, such as one or more partial bank account numbers of the account or the accounts held by the user at the financial institution providing the financial management system 102.

The financial management system 102 may include, among other logics, bank account logic 108; credit card account logic 110; network interface logic 112; account management logic 114; and financial health logic 116, including budgeting/goal logic 118, categorization logic 120, notification logic 122, and usage control logic 124. Such logics and other logics discussed herein may, in practice, be implemented in a machine (e.g., one or more computers or servers) comprising machine-readable storage media (e.g., cache, memory, internal or external hard drive or in a cloud computing environment) having instructions stored therein which are executed by the machine to perform the operations described herein. For example, the financial management system 102 may include server-based computing systems, for example, comprising one or more networked computer servers that are programmed to perform the operations described herein. In another example, the financial management system 102 may be implemented as a distributed computer system where each function is spread over multiple computer systems.

Network interface logic 112 may be used to connect the financial management system 102 to the Internet to permit users to access the financial management system 102, for example, through an online banking website or other website, through an application, through a display on the client device 106, or in other ways. For example, the network interface logic 112 may include one or more computers or web servers that provide a graphical user interface (e.g., a series of dynamically-generated web pages) for users that access the financial management system 102 through the web. The graphical user interface may be used to prompt the user to provide login information, passwords, or other authentication information or other stored tokens. Upon successfully logging in, the graphical user interface may be used to provide the user with account information. In other examples, the network interface logic 112 may provide non-confidential information (e.g., account status, goal status, budget status, notifications, etc.) to the client device 106 without requiring the user to provide login information, passwords and other authentication information or other stored tokens. The network interface logic 112 may also comprise other logic that is configured to provide an interface for other types of devices such as mobile devices (e.g., cellular phones, smart phones, tablet computers, mobile e-mail devices, etc.), fax machines, ATMs, server-based computing systems, etc. The network interface logic 112 may provide access to an application programming interface (API) for various third-party networks such as Mint®, Facebook®, LinkedIn® , EWise®, Yodlee®, etc. The network interface logic 112 may also be used to connect to third-party system logic 130 to provide access to users' accounts (e.g., bank accounts, brokerage accounts, credit card accounts, social media accounts, etc.) managed by third-parties that are external to the financial management system 102.

The account management logic 114 may interact with various backend systems in connection with maintaining financial accounts for account owners. For example, the account management logic 114 may manage bank accounts (e.g., checking and savings accounts) via bank account logic 108 and credit card accounts via credit card account logic 110. The bank account logic 108 and credit card account logic 110 may store account information for various users' accounts in one or more accounts databases 132. The account management logic 114 manages each user's accounts by facilitating, among other things, account processing, account records, statement generation, bill pay, funds transfers, etc. Account records include, among other things, records of financial transactions associated with each account. Financial transactions may include, for example, credits or debits to a user's account, such as the purchase of a good or the deposit of a paycheck, and various metadata associated therewith.

In addition to the above, the account management logic 114 provides enhanced functionality to users by utilizing financial health logic 116, including budgeting/goal logic 118, categorization logic 120, notification logic 122, and usage control logic 124. As explained in further detail below, the financial health logic 116 is configured to engage users and improve their overall financial health by providing preemptive and contextual financial notifications.

Budgeting/goal logic 118 allows users to track various financial budgets and goals. In some examples, the budgeting/goal logic 118 automatically sets default budgets and/or goals. For example, one embodiment automatically provides a budget including three budget categories according to a “50/30/20 Rule” of personal financial management. The 50/30/20 Rule provides a budget that divides after-tax income, or net pay, into three categories: (1) fifty percent for needs; (2) thirty percent for wants; and (3) twenty percent for savings and debt. “Needs” include any expenses an individual cannot forgo in a given month, such as rent, groceries and minimum payments on credit cards, mortgages and auto loans. “Wants” include expenses that are not immediately necessary, such as vacations, gifts, entertainment, clothes, and dining out. Savings and debt includes, for example, paying down credit cards, creating an emergency fund, and saving for retirement.

In some examples, the budgeting/goal logic 118 allows users to input budget and/or goal parameters to set various budgets and/or goals via a user interface, in addition to or instead of automatically defined budgets and/or goals. For example, the user interface may be configured to be displayed on the client device 106. According to various example embodiments, the user interface displays at least one budget/goal category and at least one budget/goal parameters. A user may select various budget/goal parameters (e.g., via clicking or touching the corresponding portion of the user interface) to select or to manually input a value for the selected budget/goal parameter. Budget and goal parameters may include, for example, a budget category (e.g., clothing, restaurants, bars, coffee, etc.), a merchant (e.g., Nordstrom, Gibson's, Starbucks, etc.), a time period (over a day, week, weekend, etc.), among other parameters or any combination thereof. For example, a user may set a budget or a goal to spend less than $100.00 at bars over a weekend. As another example, a user may wish to limit spending on lunches; therefore, a corresponding budget or goal may be to spend less than $50 at restaurants per week from 11:30 a.m. to 1:30 p.m. each day. It should be understood that these are merely two non-limiting examples of the myriad budgets and goals that can be defined by users.

In some examples, the budgeting/goal logic 118 allows a user to identify merchants or locations at which a user wishes to avoid spending money. For example, a user may realize that he or she has a hard time avoiding buying donuts whenever he or she walks past a particular donut shop. Therefore, the user may include the particular donut shop and/or its corresponding location (e.g., street address, GPS coordinates, etc.) in a “prohibited merchant” or “prohibited location” list.

Categorization logic 120 categorizes transactions within various budget and/or goal categories. Such categorization is utilized by the other logics that make up the financial health logic 116, including the budgeting/goal logic 118, the notification logic 122, and the usage control logic 124, to improve a user's financial health based on the user's financial behavior.

The categorization logic 120 includes logic to categorize both executed transactions 126 and anticipated transactions 128. Categorizing executed transactions 126 allows a user to analyze his or her financial behavior ex post, or after the fact. For example, users may analyze their past financial behavior to identify bad habits, which they can attempt to correct in the future. In contrast, anticipating potential transactions and categorizing the anticipated transactions 128 allows a user to analyze and control his or her financial behavior ex ante, or before the fact. Thus, for example, users may be able to avoid potential behavior that can lead to bad financial habits.

The categorization logic 120 categorizes executed transactions 126 in various ways. In some embodiments, the categorization logic 120 facilitates manual transaction categorization by a user. In other embodiments, the categorization logic 120 automatically “pre-categorizes” or “suggests” categorization based on a user's prior usage or categorization history, or based on other parameters (e.g., merchant, merchant category, amount, anonymized data, etc.). In further embodiments, the categorization logic 120 automatically categorizes transactions, which a user may later re-categorize if he or she disagrees with the automatic categorization. The categorization logic 120 is configured to “learn” from users' categorization history, transaction history, and corresponding patterns or habits to optimize subsequent automatic categorization or pre-categorization. According to various examples, the budgeting/goal logic 118 leverages the categorization logic 120 to track users' budget and/or goal status for various categories (e.g., dining, entertainment, transportation, etc.).

The categorization logic 120 also utilizes geo-fencing to determine categories and/or anticipated categories based on geolocation information (e.g., GPS coordinates, street address, etc.) received from the client device 106. Anticipated categories refer to categories of anticipated transactions 128 that a user would most likely conduct based on the user's geolocation. For example, the categorization logic 120 may determine that a user is near (e.g., within a pre-determined radius of) a particular merchant based on a location identifier received from the client device 106, and may further determine an anticipated category based on the particular merchant. In some examples, the categorization logic 120 cross-references the location identifier with a list or a database to determine a merchant and a corresponding category. In some examples, the categorization logic 120 accesses third-party systems (e.g., Google Maps®, Yelp®, Foursquare®, etc.) via the third-party system logic 130 to determine a merchant and/or a corresponding category based on a location identifier. For example, the categorization logic 120 may determine that a user is at a first location that is within a threshold radius of a second location, which corresponds to a Nordstrom. In this example, the categorization logic 120 may predict that the user would be most likely to conduct an anticipated transaction 128 at Nordstrom, which would most likely be categorized as “clothing.” In some examples, the categorization logic 120 further determines an anticipated transaction amount associated with an anticipated transaction 128. Anticipated transaction amounts can be based on past executed transactions 126 by the user at a merchant or within a budget category, based on average check size for a merchant, or based on other information.

In some examples, the categorization logic 120 further uses geo-fencing capabilities based on proximity beacons to provide geolocation information with enhanced precision. For example, a merchant may position proximity beacons strategically throughout a geographic location, e.g., a retail store. Each beacon may include memory that stores program modules that, when executed by the processor, control operation of the beacon. The beacons may also store a unique beacon identifier and include a transmitter (e.g., a Bluetooth® transmitter) that broadcasts the unique beacon identity within a limited, configurable range of the beacon. In some arrangements, the beacons are Bluetooth® Low Energy beacons (e.g., iBeacons®). The maximum broadcast range may be increased or decreased by respectively increasing or decreasing the broadcast power of each beacon. In some arrangements, the categorization logic 120 maintains a database (sometimes for each account holder) of beacon identities and associated locations. Each entry in the database includes a beacon identity (e.g., a serial number that is broadcast from the beacon) and an associated location (e.g., an identifier of the geographic location and an identifier of the placement within or outside of the geographic location). When the client device 106 detects a beacon, the beacon identifier may be transmitted to the financial management system 102, thereby enabling the categorization logic 120 of the financial management system 102 to determine the precise location of the client device 106 within the retail store. For example, a user that wishes to stop purchasing so much of a particular product at large retail store may create an alert when the user is at the particular location in the store where that product is sold. Thereafter, the next time the user is at that location in the store, the user may automatically receive the previously-programmed alert advising the user not to purchase that particular product. In some examples, a beacon identifier or a beacon location can be used in conjunction with a location identifier (e.g., a GPS signal) to determine a precise location.

Notification logic 122 manages notifications that are provided to users. For example, the notification logic 122 may provide notifications (e.g., push notifications, SMS messages, etc.) to the client device 106 of the user. The particular content and triggering parameters of the notifications may be user-defined and/or may be automatically defined (e.g., by the financial institution that provides the financial management system 102). Notification content may include, among other things, account balances, budget or goal statuses, warnings, messages, etc. Notifications may be provided in real-time or near real-time. Notifications may be triggered based on various parameters, including both executed and anticipated transactions 126, 128. For example, notifications may be triggered based on executed transactions 126, such as a budget or goal being exceeded by executed transactions 126 or being within a threshold value of being exceeded, for example. Further, notifications may be set to automatically expire upon certain conditions occurring. For example, notifications relating to a savings goal may be set to expire once the savings goal is met. In another example, a savings goal may be tied to a location (e.g., a vacation destination), and the notification may be set to expire, or may prompt the user to cancel the notification, upon the location being detected (e.g., detected by the client device 106 or based on transaction data). For example, the user may indicate that a savings goal for a trip to Texas. Upon detecting that the user is in Texas (e.g., based on GPS signals, based on credit card transactions occurring on the user's credit card account from merchants based in Texas, or in another manner), the system may prompt the user whether wishes to cancel the savings goal, given that the trip to Texas has in fact now occurred. Thus, in some examples, notifications may dynamically change based on various events, such as those relating to financial activity, location, etc.

The notification logic 122 may also trigger notifications preemptively based on anticipated transactions 128. For example, certain notifications may be triggered if the user is within a predetermined radius of a particular merchant or of a merchant corresponding to a particular budget category (e.g., a merchant at which an anticipated transaction 128 would most likely be categorized in the particular budget category). In some examples, the notification logic 122 may provide a notification comprising, for example, a budget status for a particular budget category based on a user's geolocation. For example, based on a user's geolocation, the notification logic 122 may determine that the user is near a clothing store. Therefore, the notification logic 122 may provide a notification including a current status (e.g., available balance) of the user's clothing budget. In some examples, the notification logic 122 may provide a notification including an alert to not spend money at a particular merchant or location (e.g., a particular merchant or location included in a “prohibited merchant” or “prohibited location” list). For example, the notification logic 122 may provide such an alert when the client device 106 is within a threshold radius of the particular merchant or location.

In some examples, users may set notifications via the notification logic 122 for other users that are associated with the user's financial account, e.g., a user's spouse. For example, a user may set a notification for her husband based on a particular section of a retail store (e.g., the precise location of that section may be determined based on beacon signals). For example, the notification may be set based on hardware section of a local home center and state “honey, you promised you wouldn't by any more power tools until we saved up enough money for a vacation.” Thus, the next time that the user's husband is at the hardware section of the local home center, the notification logic 122 would detect his location and provide the message.

Usage control logic 124 allows users to set various restrictions on their own financial accounts (e.g., credit card accounts or bank accounts) and on financial accounts that the users are authorized to control, such as their children's accounts. Certain users find it difficult to proverbially “balance their checkbook” or, in other words, to keep track of their purchases relative to their financial goals and budgets. The usage control logic 124 is configured to allow authorized users to set, update, and control various parameters to automatically restrict usage if certain parameters are exceeded. The usage parameters may be set according to predetermined spending limits based on certain transaction categories, merchants, time of use, etc. The usage control logic 124 allows authorized users full control over setting, updating, and/or opting out of various usage restrictions.

According to an example embodiment, the usage control logic 124 provides authorized users the ability to define trusted and prohibited merchants, such that transactions are prohibited or the account is temporarily “frozen” if transactions are attempted at a prohibited merchant. As another example, users can define usage parameters that only allow recurring charges from trusted merchants. In one example, the usage control logic 124, via the notification logic 122, provides a notification to a user if a recurring charge is attempted from a non-trusted merchant, and does not accept the charge until it is approved by the user. In some embodiments, the usage control logic 124 automatically sets certain usage parameters based on parental controls, such as parental phone usage controls.

According to an example embodiment, the usage control logic 124 filters context-sensitive advertisements based on various parameters, such as a budget or goal status and/or geolocation, among others. For example, if a user's budget for a particular budget category, such as clothing, has been exceeded, the usage control logic 124 can filter advertisements such that clothing advertisements are not displayed. As another example, if a user's clothing budget has a certain amount remaining, the usage control logic 124 can prioritize clothing advertisements. In some situations, advertisements from particular merchants may be filtered (e.g., blocked or prioritized) further based on the user's geolocation (e.g., proximity to particular merchants).

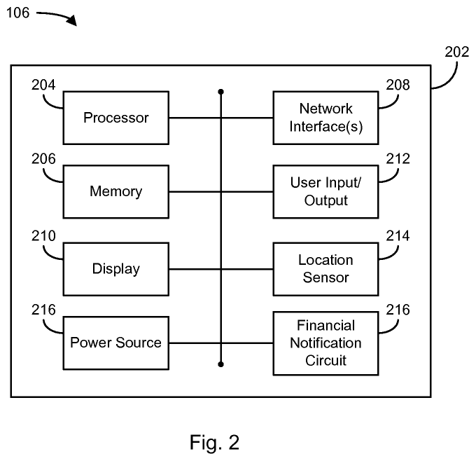

Referring to FIG. 2, a block diagram of the client device 106 of FIG. 1 is shown according to an example embodiment. According to various example embodiments, the client device 106 is a laptop computer, tablet computer, PDA, smartphone, portable media device, wearable device, augmented reality device, etc. The client device 106 includes a housing 202. The housing 202 is coupled to the various electrical components of the client device 106. The client device 106 also includes a processor 204 and memory 206. The memory 206 includes program modules that, when executed by the processor 204, control the operation of the client device 106. The memory 206 may also store various applications, such as an application of the financial institution that facilitates communication between the client device 106 and the various computing systems of the financial management system 102. The memory 206 may include any combination of RAM, ROM, NVRAM, etc.

The client device 106 also includes at least one network interface 208. In one example, the network interface 208 is a wireless network interface. The network interface 208 includes any of a cellular transceiver (e.g., CDMA, GSM, LTE, etc.), a wireless network transceiver (e.g., 802.11X, Bluetooth, NFC, Bluetooth Low Energy (BLE), RFID, ZigBee, etc.), or a combination thereof (e.g., both a cellular transceiver and a Bluetooth transceiver). The network interface 208 is capable of communicating with the notification device 108 (e.g., via 802.11x, Bluetooth, BLE, NFC, RFID, etc.). Additionally, the network interface 208 is capable of communicating with the financial management system 102 via the network interface logic 114 over the network 104 (e.g., via the Internet as accessed through a cellular data network).

The client device 106 also includes a display 210 and a user input/output 212. In some examples, the display 210 and the user input/output are combined (e.g., as a touchscreen display device). In other examples, the display 210 and the user input/output 212 are discrete devices. The user input/output 212 includes any of touchscreen displays, buttons, speakers, keyboards, notification LEDs, microphones, biometric sensors (e.g., fingerprint scanners), switches, cameras, or a combination thereof

In some examples, the client device 106 includes a location sensor 214 (e.g., a GPS device) for determining the location of the client device 106. The client device 106 also includes a power source 216. The power source 216 may include any combination of grid power and battery power (e.g., alkaline batteries, lithium batteries, rechargeable batteries, etc.). In examples where the power source 216 is a rechargeable battery, the client device 106 also includes the circuitry necessary to recharge the battery.

The client device 106 also includes a financial notification circuit 216. The financial notification circuit 216, alone or in conjunction with the financial health logic 116 of the financial management system 102, is configured to provide notifications to users (e.g., via the display 210 of the client device 106) in real-time or near real-time. As described above in connection with the notification logic 122, the financial notification circuit 216 may provide notifications based on both executed and anticipated transactions 126, 128, based on location (e.g., determined via the location sensor 214), etc. In order to make the financial notification circuit 216, the financial management system 102 may provide a software application that is available to be downloaded onto the client device 106 (e.g., directly or via an app store). Installation of the software application may then be performed. Thereafter, the thus-modified client device 106 includes the financial notification circuit 216 (embodied as a processor and instructions stored in non-transitory memory that are executed by the processor).

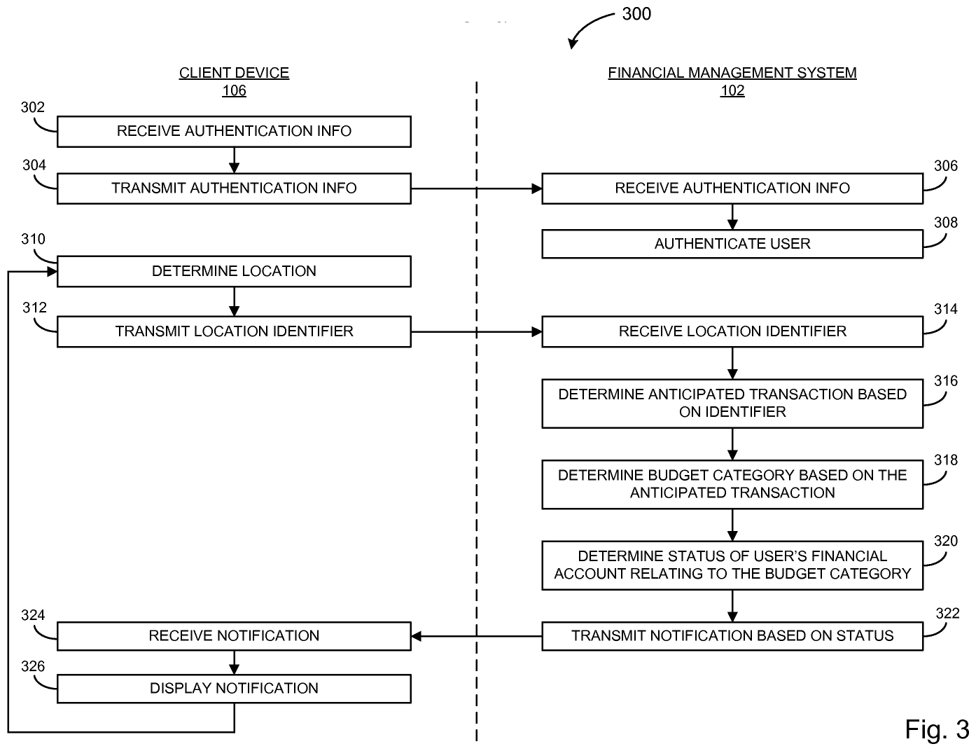

Turning to FIG. 3, a flow diagram of a method 300 of providing preemptive and contextual financial notifications is illustrated according to an example embodiment. For the purposes of clarity and brevity, the method 300 is described with respect to the financial management system 102 of FIG. 1 and the client device 106 of FIGS. 1 and 2. However, the method 300 may similarly be performed by other devices. The method 300 of FIG. 3 illustrates the interaction between the client device 106 (left-most column) and the financial management system 102 (right-most column).

302-308 are performed initially to authenticate the user of the client device 106 with the financial management system 102 so that the user may access, via the client device 106, information relating to one or more of the user's financial accounts that are managed by the financial management system 102. At 302, the client device 106 receives authentication information from the user. The user provides the authentication information via the user input/output 212 of the client device 106. The authentication information includes any of a password, a PIN, a user ID, an answer to a verification question, a biometric (e.g., a picture of the user's face, a fingerprint, a voice sample, a retina scan, etc.), an identification of a security image, or a combination thereof. In some examples, no user authentication information is required. In some examples, at least a portion of the authentication information is provided in the form of a customer token and/or a device token stored on the client device 106. The customer token and device token may be tokens that identify the user and the associated client device 106 to the backend financial management system 102 in the future. The tokens are initially created by and encrypted by the financial management system 102 and then transmitted to the client device 106. The tokens may be created as part of installing the financial institution application on the client device 106. After the tokens are created and stored on the client device 106, the tokens may be used to supplement or as a substitute for manually entered authentication provided by the user via the client device 106. In an example embodiment, each time the user accesses the financial management system 102 with a new client device, the new client device is assigned its own device token. A device and customer token are stored on each device in order to bind the device to the user (one client device can only have financial institution user associated with it, but one user can have multiple client devices). In other embodiments, a client device may be associated with multiple users. Once a client device is registered with the user, the user may be required to manually enter less information during an authentication process than if the tokens are not present on the client device. For example, the user may have an online banking password consisting of a combination of eight or ten or more characters including numbers, upper and lower case characters, punctuation marks, and so on. Rather than enter the full online banking password, the user may only need to enter their existing ATM PIN, device password, or other information to be authenticated via the registered device. Possession by the user of the registered client device provides an additional level of authentication that avoids the need for full login credentials.

At 304, the authentication information is transmitted from the client device 106 to the financial management system 102. The financial management system 102 receives the authentication information at 306 and authenticates the user at 308. The financial management system 102 compares the received authentication information with stored and verified authentication information relating to the user. If the provided authentication information does not match, the financial management system 102 sends a notification to the client device 106 indicating the information does not match. In these situations, the user may be prompted to reenter authentication information (e.g., method 300 reverts back to 302).

At 310, the client device 106 determines its location, which is represented by a location identifier. According to various example embodiments, the client device 106 can determine its location in different ways. In one example, the client device 106 determines its location based on its location sensor 214 (e.g., GPS or GLONASS sensor). In another example, the client device 106 determines its information from cell tower triangulation. In another example, the client device 106 receives a beacon signal from one or more locator beacons, which may be used to determine the location of the client device 106. For example, the beacons may be Bluetooth® Low Energy (BLE) beacons (e.g., iBeacons®).

At 312, the client device 106 transmits the location identifier and at 314, the financial management system 102 receives the location identifier. The location identifier can include GPS or GLONASS coordinates, an address, a beacon identifier (e.g., a serial number or code that is broadcast from a beacon), etc.

At 316, the financial management system 102 determines an anticipated transaction 128 based on the identifier. In one example, the categorization logic 120 of the financial management system 102 determines, based on the identifier, that the client device 106 is near (e.g., within a pre-determined radius of) a particular merchant. In some examples, the categorization logic 120 accesses third-party systems (e.g., Google Maps®, Yelp®, Foursquare®, etc.) via third-party system logic 130 to determine the merchant based on the identifier. The categorization logic 120 can then determine an anticipated transaction 128 based on the merchant, based on historical executed transactions 126 of the user or of other users. In some examples, the anticipated transaction 128 includes a dollar amount.

At 318, the financial management system 102 determines a budget category based on the anticipated transaction 128. For example, if at 316 the categorization logic 120 determined that the anticipated transaction 128 included gas to be purchased from a gas station, the categorization logic may determine that the budget category for the anticipated transaction 128 is “transportation.”

At 320, the financial management system 102 determines a status of the user's financial account relating to the budget category determined at 318. As mentioned above, the user has one or more financial accounts that are managed by the financial management system 102, which the budgeting/goal logic 118 can manage according to various budget categories. The status determined at 320 can include, for example, a budgeted amount, a spent amount, and/or a remaining amount relating to the budget category determined at 318.

At 322, the financial management system 102 transmits a notification based on the status determined at 320 to the client device 106. At 324, the client device 106 receives the notification and at 326, the client device 106 displays the notification. In one example, the notification includes a balance of the budget category, such as an amount spent on transactions attributed to the budget category over a particular time period versus a budgeted amount for the particular time period. In another example, the notification includes a message or warning. For example, if the user has exceeded a budgeted amount for the budget category and the anticipated transaction 128 corresponds to the budget category, the message may include a warning to avoid the merchant.

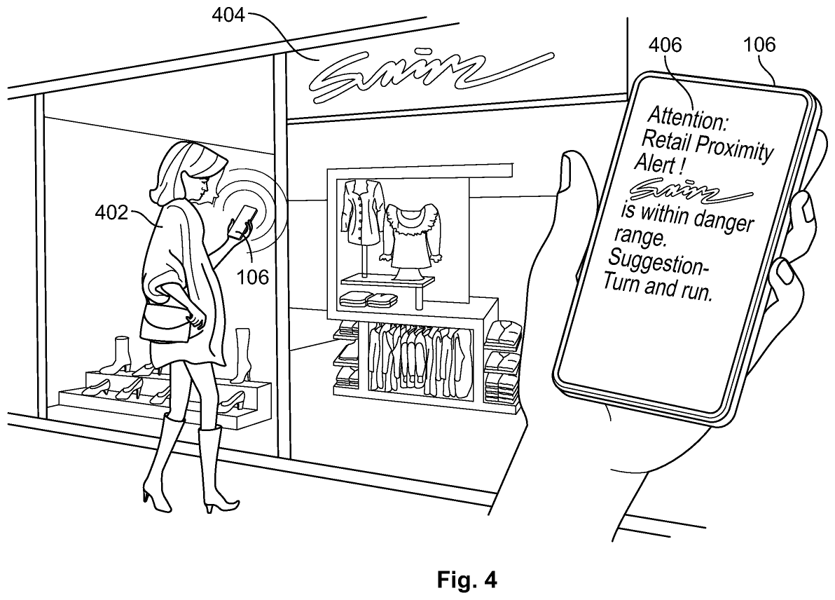

Turning to FIG. 4, an example implementation of the method 300 of FIG. 3 is illustrated. As shown in FIG. 4, a user 402 is holding the client device 106 (FIGS. 1 and 2). As shown in FIG. 4, the user 402 is near a merchant 404 and has received a notification 406 on the client device 106. For example, the financial management system 102 may have determined that the client device 106 is within a threshold radius of a particular merchant 404, based on a location identifier received from the client device 106. Accordingly, the financial management system 102 determined that an anticipated transaction 128 would likely be conducted with the merchant 404.

The notification 406 was generated based on status of the user's financial account relating to the budget category of the anticipated transaction 128. For example, the financial management system 102 may have determined that the user has exceeded a budgeted amount for his or her “clothing” budget category, and that an anticipated transaction 128 with the merchant 404 would correspond to his or her “clothing” budget category. Therefore, the notification 406 includes a warning to avoid the merchant 404. Thus, the notification 406 preemptively warns the user 402 about potential financial activity (e.g., an anticipated transaction 128 with the merchant 404) that may harm the user's financial health.

Accordingly, the user is being provided with real-time or near real-time budget and alert information at the moment that they might be contemplating a purchase. The location of the user may be used to filter budget information to make it timely and relevant based on the current location of the user. For example, when a user is at a clothing store, information about the user's dining out budget is not particularly relevant, but information about the user's clothing budget may be considered more relevant. By filtering the user's overall budget information down to that information which is the most relevant to the user at a particular moment in time (e.g., delivering clothing budget information when the user is at a clothing store), the amount of information that is to be presented to the user is limited to an amount that may be conveniently displayed on a client device such as a smartphone or other similar device, which may be conveniently carried by the user at a potential point of purchase. A full size screen such as used by a laptop computer (which would be inconvenient to carry at a point of purchase) is not needed. Thus, the present system enables more timely delivery of spending and budget alerts.

The embodiments of the present invention have been described with reference to drawings. The drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media may be any available media that may be accessed by a general purpose or special purpose computer or other machine with a processor. By way of example, such machine-readable media may comprise RAM, ROM, EPROM, EEPROM, CD-ROM or other optical disk storage, magnetic disk storage or other magnetic storage devices, or any other medium which may be used to carry or store desired program code in the form of machine-executable instructions or data structures and which may be accessed by a general purpose or special purpose computer or other machine with a processor. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the present invention have been described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

As previously indicated, embodiments of the present invention may be practiced in a networked environment using logical connections to one or more remote computers having processors. Those skilled in the art will appreciate that such network computing environments may encompass many types of computers, including personal computers, hand-held devices, multi-processor systems, microprocessor-based or programmable consumer electronics, network PCs, minicomputers, mainframe computers, and so on. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a computing system in the form of computers, including a processing unit, a system memory or database, and a system bus that couples various system components including the system memory to the processing unit. The database or system memory may include read only memory (ROM) and random access memory (RAM). The database may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer. It should also be noted that the word “terminal” as used herein is intended to encompass computer input and output devices. User interfaces, as described herein may include a computer with monitor, keyboard, a keypad, a mouse, joystick or other input devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present invention. Such variations will depend on the software and hardware systems chosen and on designer choice. It is understood that all such variations are within the scope of the invention. Likewise, software and web implementations of the present invention could be accomplished with standard programming techniques with rule based logic and other logic to accomplish the various database searching steps, correlation steps, comparison steps and decision steps.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangement of the embodiments without departing from the scope of the present invention.

Throughout the specification, numerous advantages of the exemplary embodiments have been identified. It will be understood of course that it is possible to employ the teachings herein without necessarily achieving the same advantages. Additionally, although many features have been described in the context of a particular data processing unit, it will be appreciated that such features could also be implemented in the context of other hardware configurations.

While the exemplary embodiments illustrated in the figures and described above are presently preferred, it should be understood that these embodiments are offered by way of example only. Other embodiments may include, for example, structures with different data mapping or different data. The invention is not limited to a particular embodiment, but extends to various modifications, combinations, and permutations that nevertheless fall within the scope and spirit of the appended claims.

1. A system, comprising:
a financial notification circuit located on a client device, the financial notification circuit configured to:
determine a present location of the client device,
determine a merchant based on the present location of the client device,
determine that the present location is within a specific section of a store of the merchant, wherein the specific section comprises a subsection of a geographical area of the store;
determine an anticipated transaction based on past transactions by a user with the merchant and the determination that the present location is within the specific section of the store of the merchant, the user associated with the client device,
determine a budget category based on the anticipated transaction, the budget category associated with a financial account of the user,
determine a budget status of the user's financial account, the budget status including an amount spent on transactions attributed to the budget category over a predetermined time period,
filter the budget status to remove budget information for budget categories other than the budget category corresponding to the anticipated transaction, and
provide a real-time contextual budget notification on a user interface of the client device, the real-time contextual budget notification comprising the filtered budget status.

2. The system of claim 1, wherein the financial notification circuit is configured to provide, via the user interface, a prompt for the user to identify at least one prohibited location at which the user wishes to avoid spending money.

3. The system of claim 2, wherein the present location is within a predetermined threshold radius of at least one of the identified prohibited locations.

4. The system of claim 2, wherein each of the identified prohibited locations corresponds to a particular merchant.

5. The system of claim 1, wherein the financial notification circuit is configured to provide, via the user interface, a prompt for the user to identify at least one merchant at which the user wishes to avoid spending money.

6. The system of claim 5, wherein a second notification is provided on the user interface if the merchant associated with the present location is one of the identified merchants at which the user wishes to avoid spending money.

7. The system of claim 6, wherein the merchant associated with the present location is within a predetermined threshold radius of the present location.

8. The system of claim 1, wherein a second notification is provided on the user interface of the client device if the amount spent on transactions attributed to the budget category over a predetermined time period is within a threshold amount of a budgeted amount or exceeds the budgeted amount for the budget category for the predetermined time period.

9. The system of claim 1, wherein the financial notification circuit is configured to determine the present location of the client device based on received GPS coordinates.

10. The system of claim 1, wherein the financial notification circuit is configured to determine the present location of the client device based on a received beacon identifier.

11. A computer-implemented method, comprising:
determining, by a financial notification circuit located on a client device, a present location of the client device;
determining a merchant based on the present location of the client device;
determining that the present location is in a specific section of a store of a merchant wherein the specific section comprises a subsection of a geographical area of the store;
determining an anticipated transaction based on past transactions by a user with the merchant and the determination that the present location is within the specific section of the store of the merchant, the user associated with the client device;
determining a budget category based on the anticipated transaction;
determining a budget status of the user's financial account, the budget status including an amount spent on transactions attributed to the budget category over a predetermined time period;
filtering the budget status to remove budget information for budget categories other than the budget category corresponding to the anticipated transaction; and
providing a real-time contextual budget notification on a user interface of the client device, the real-time contextual budget notification comprising the budget status for only the budget category corresponding to the anticipated transaction.

12. The method of claim 11, further comprising providing, by the financial notification circuit via the user interface, a prompt for the user to identify at least one prohibited location at which the user wishes to avoid spending money.

13. The method of claim 12, wherein the present location is within a predetermined threshold radius of at least one of the identified prohibited locations.

14. The method of claim 12, wherein each of the identified prohibited locations corresponds to a particular merchant.

15. The method of claim 11, further comprising providing, by the financial notification circuit via the user interface, a prompt for the user to identify at least one merchant at which the user wishes to avoid spending money.

16. The method of claim 15, wherein a second notification is provided if the merchant associated with the present location is one of the identified merchants at which the user wishes to avoid spending money.

17. The method of claim 16, wherein the merchant associated with the present location is within a predetermined threshold radius of the location.

18. The method of claim 11, wherein the notification alerting the user of the budget status is provided on the client device if the budget status identifies that the amount spent on transactions attributed to the budget category over a predetermined time period is within a threshold amount of a budgeted amount or exceeds the budgeted amount for the budget category for the predetermined time period.

19. The method of claim 11, further comprising determining, by the financial notification circuit, the present location of the client device based on received GPS coordinates.

20. The method of claim 11, further comprising determining, by the usage control circuit, the present location of the client device based on a received beacon identifier.

21. A computer-implemented method of providing automatic financial notifications to a client device, the method comprising:
receiving, by a processor of a banking system, authentication information from the client device, the authentication information relating to a financial account of a user;
authenticating, by the processor, the user so as to associate the client device with the financial account of the user;
receiving, by the processor, a present location identifier from the client device;
determining, by the processor, a merchant based on the present location identifier;
determining, by the processor, that the present location is in a specific section of a store of the merchant, wherein the specific section comprises a subsection of a geographical area of the store;
determining, by the processor, an anticipated transaction based on past transactions by the user with the merchant and the determination that the present location is within the specific section of the store of the merchant, the user associated with the client device;
determining, by the processor, a budget category based on the anticipated transaction;
determining, by the processor, a status of the user's financial account, the status relating to the budget category;
filtering, by the processor, the budget status to remove budget information for budget categories other than the budget category corresponding to the anticipated transaction; and
providing, by the processor via a user interface of the client device, a real-time contextual budget notification comprising the budget status for only the budget category corresponding to the anticipated transaction.

22. (canceled)

23. The method of claim 21, wherein the present location identifier corresponds to a first location and wherein the merchant corresponds to a second location, the first location being within a predetermined threshold radius of the second location.

24. The method of claim 23,
wherein the budget status identifies that the user has exceeded a predetermined budget for the budget category,
wherein the merchant is associated with the budget category, and
wherein the budget notification includes a warning to avoid the merchant.

25. The method of claim 23, wherein the first location is cross-referenced with a third-party merchant database to determine the merchant.

26. The method of claim 21, wherein the budget status includes an amount spent on transactions attributed to the budget category over a predetermined time period versus a budgeted amount for the budget category for the predetermined time period.

27. The method of claim 26, wherein the budget notification identifies that the amount spent on transactions attributed to the budget category exceeded the budgeted amount for the predetermined time period.

28. The method of claim 21, wherein the budget status includes a goal progress related to the budget category.

29. The method of claim 21, wherein the budget notification includes one or more shapes sized in proportion to respective amounts associated with the budget category.

30. The method of claim 21, wherein the present location identifier includes GPS coordinates.

31. The method of claim 21, wherein the present location identifier includes a beacon identifier.

32-33. (canceled)

34. A system comprising:
a data storage system; and
a processor and program logic stored in memory and executed by the processor, the program logic including financial health logic configured to:
receive authentication information from the client device, the authentication information relating to a financial account of a user;
authenticate the user so as to associate the client device with the financial account of the user;
receive a present location identifier from the client device;
determine a merchant based on the present location identifier;
determine that the present location is in a specific section of a building of the merchant, wherein the specific section comprises a subsection of a geographical area of the store;
determine an anticipated transaction based on past transactions by the user with the merchant and the determination that the present location is within the specific section of the building of the merchant, the user associated with the client device;
determine a budget category based on the anticipated transaction;
determine a budget status of the user's financial account, the budget status relating to the budget category; and
filter the budget status to remove budget information for budget categories other than the budget category corresponding to the anticipated transaction; and
provide, via a user interface of the client device, a real-time contextual budget notification comprising the filtered budget status.

35. (canceled)

36. The system of claim 34, wherein the present location identifier corresponds to a first location and wherein the merchant corresponds to a second location, the first location being within a predetermined threshold radius of the second location.

37. The system of claim 36,
wherein the budget status identifies that the user has exceeded a predetermined budget for the budget category,
wherein the merchant is associated with the budget category, and
wherein the budget notification includes a warning to avoid the merchant.

38. The system of claim 36, wherein the first location is cross-referenced with a third-party merchant database to determine the merchant.

39. The system of claim 34, wherein the budget status includes an amount spent on transactions attributed to the budget category over a predetermined time period versus a budgeted amount for the budget category for the predetermined time period.

40. The system of claim 39, wherein the budget notification identifies that the amount spent on transactions attributed to the budget category exceeded the budgeted amount for the predetermined time period.

41. The system of claim 34, wherein the budget status includes a goal progress related to the budget category.

42. The system of claim 34, wherein the budget notification includes one or more shapes sized in proportion to respective amounts associated with the budget category.

43. The system of claim 34, wherein the present location identifier includes GPS coordinates.

44. The system of claim 34, wherein the present location identifier includes a beacon identifier.

45-50. (canceled)
